(19) United States
(12) Patent Application Publication
(10) Pub. No.: US 2026/0331348 A1
(43) Pub. Date: Oct. 22, 2026

(54) Coil Assembly for a Power Voltage Transformer

(71) Applicant: HSP Hochspannungsgeräte GmbH, Troisdorf (DE)

(72) Inventors: Udo Prucker, Schwaig (DE); Wolfgang Knab, Hallstadt (DE); Andreas Winderlich, Oberaurach (DE)

(21) Appl. No.: 19/112,134

(22) PCT Filed: Aug. 30, 2023
(86) PCT No.: PCT/EP2023/073770

§ 371 Date: Mar. 14, 2025

(30) Foreign Application Priority Data
Sep. 16, 2022 (DE) 102022209761.0

(51) Int. Cl. H01F 27/00; H01F 27/245; H01F 27/32; H01F 30/10

(52) U.S. Cl. CPC H01F 27/006; H01F 27/245; H01F 27/321; H01F 30/10

(57) ABSTRACT

A coil assembly for a power voltage transformer is disclosed. One aspect includes comprising two high-voltage coils of substantially identical configuration that are connected in parallel. Each of the two high-voltage coils includes a primary winding and a secondary winding.

The present invention relates to a coil assembly for an, in particular inductive, power voltage transformer, in particular for voltage transformation in energy supply systems of high-voltage technology.

Such power voltage transformers are preferably configured as or like transformers or transformer devices which are directly connected at the primary side to high-voltage lines or busbars for high voltages, for example up to several hundred kilovolts. On the secondary side, electrical powers at relatively low secondary voltages, for example at secondary voltages up to a few hundred volts, can be provided. Such transformer devices are suitable applications such as self-supply of substations or energy supply of rural areas or construction sites from high-voltage networks.

In order to increase the power of such transformers, a wire or conductor cross-section size, and thus the power loss in the device, can be adjusted to a corresponding output power. However, this results in a greater space requirement for the two (i.e., primary and secondary) windings and thus a larger size or a less compact structure of the overall active part. Alternatively, or in addition, the induction and a core cross-section of the magnet core used can vary within certain limits, for power optimisation, via the parameter of the number of windings.

However, an increase in the size of the core cross section or core window results in higher core costs and brings about an increase in the size of the coil, in particular with respect to the width and height of the winding, which then has a negative effect on the heat dissipation from the component.

The increase in the size of the coil furthermore disadvantageously causes—on account of the greater use of material—higher production costs of the overall component, since in particular also the housing and possibly a voltage connection would have to be adjusted or configured differently. Therefore, the greater coil weight has a negative impact on the connection or the mounting of the component, since in particular larger cranes or mounting devices and/or a more complex support must be made available.

An object of the present invention is therefore that of specifying an improved coil assembly for power voltage transformers, which in particular makes it possible to operate the components in question using a significantly increased overall current or a significantly increased overall power.

This object is achieved by the subject matter of the independent claims. The dependent claims relate to advantageous embodiments.

One aspect of the present invention relates to a coil assembly for an, in particular inductive, power voltage transformer, wherein the coil assembly comprises at least two, i.e. two or more, high-voltage coils of the same type that are connected in parallel or are to be or can be interconnected accordingly. The high-voltage coils are in each case constructed in the manner of or as a transformer having a high voltage-side primary winding and a secondary winding on the low-voltage side. Accordingly, the high-voltage coils are preferably coils or coil components on the primary side that are configured for high-voltage applications.

Furthermore, the coil assembly according to the invention is preferably configured for power voltage transformer applications, in particular in single-phase operation.

The (primary-side) parallel interconnection of the two coils means that the overall current and thus the overall power can advantageously be increased, in particular doubled, at the same core cross-section and preventing the disadvantages mentioned above. Accordingly, the power voltage transformer, as a component, has the possibility of providing, drawing or processing significantly higher powers (output powers).

Furthermore, the thermal behaviour of each individual coil (individual high-voltage coil) is advantageously retained, without the above-described disadvantages arising that in particular a larger coil has to be provided which is characterised inter alia by a significantly poorer heat discharge.

Furthermore again, the housing diameter is advantageously similar or identical to that of a device of the same design which for example provides only half the output power.

Advantageously, when using the coil assembly according to the invention in power voltage transformers, moreover only the housing has to be increased in size, in one dimension, which is less notable in terms of costs than an increase in the size of the conductor or magnetic core cross-section.

Moreover, the handling of the coil assembly for the described purposes in or during mounting is advantageously made easier on account of two separate or individual coils or coil pairs.

In one embodiment, the secondary windings of the high-voltage coils are in each case arranged further inside the coils or coil assembly, and the primary windings are in each case located further outside.

In one embodiment, the two high-voltage coils of the same type are configured or finished identically. This embodiment in particular offers the advantages, described in detail above, of mounting, bringing into operation, as well as overall the dimensioning of the coil assembly for its intended use. Deviating from this embodiment, however, the advantages according to the invention can also be made use of in part in the case of high-voltage coils that are merely of the same type but are not completely identical.

In one embodiment, the two high-voltage coils of the same type are arranged symmetrically on a common magnetic core of laminated and/or pressed sheet iron or in a tape-wound core configuration. This embodiment is advantageous in particular for the electrical properties of the coil assembly for voltage transformer applications of high-voltage technology, in particular for loss reduction and increasing efficiency.

In one embodiment, the primary windings of the high-voltage coils are wound in such a way that corresponding magnetic field strengths—during operation of the coil assembly or the voltage transformer as intended—in the magnetic core have the same sense of direction or the same (revolving) field direction.

In one embodiment, the primary winding is in each case wound or configured to be rotationally symmetrical, for example toroidal or plate-like. This embodiment is advantageous in particular for the electrical properties of the coil assembly for voltage transformation applications, in particular for loss reduction and increasing efficiency.

In one embodiment, the primary windings of the two high-voltage coils of the same type are in each case configured to be electrically connected, in parallel, to a high voltage to be transformed.

In one embodiment, the coil assembly—compared with a comparison model or component of the high-voltage coil having the same magnetic core cross-section—is configured to increase, in particular to double, a secondary-side overall current or an overall power of the power voltage transformer.

In one embodiment, the coil assembly is not suitable in a cascaded arrangement of the individual high-voltage coils, or the corresponding coil components are not electrically connected in series.

A further aspect of the present invention relates to a power voltage transformer comprising the described coil assembly, wherein the two high-voltage coils of the same type are arranged in a parallel connection. This design and embodiment of the power voltage transformer makes it possible, with a compact design, to also make use of the advantages according to the invention for the superordinate component.

In one embodiment, the two high-voltage coils of the same type are arranged (vertically) one above the other, according to the intended arrangement of the power voltage transformer. This embodiment advantageously allows for a compact design of the power voltage transformer.

In one embodiment, the two high-voltage coils of the same type are arranged on or wound around opposing legs of a common magnetic core of the coil assembly. This embodiment also advantageously allows for a compact design of the coil assembly.

In one embodiment, a main insulating medium within a housing of the power voltage transformer is gaseous during operation, in particular synthetic or purified air. This embodiment expediently allows for reliable insulation to be provided and at the same time climate-damaging sulphur hexafluoride, as an insulating medium, to be omitted.

A further aspect of the present invention relates to the use of the above-described coil assembly for increasing, in particular doubling, the overall current and/or the overall power of a (or in or at) a power voltage transformer(s).

Embodiments, features and/or advantages which relate in the present case to the coil assembly can furthermore relate directly to the power voltage transformer, and vice versa.

The expression “and/or” or “or” used here, when used in a series of two or more elements, means that each of the listed elements can be used alone, or any combination of two or more of the listed elements can be used.

Further details of the invention will be described in the following with reference to the drawings.

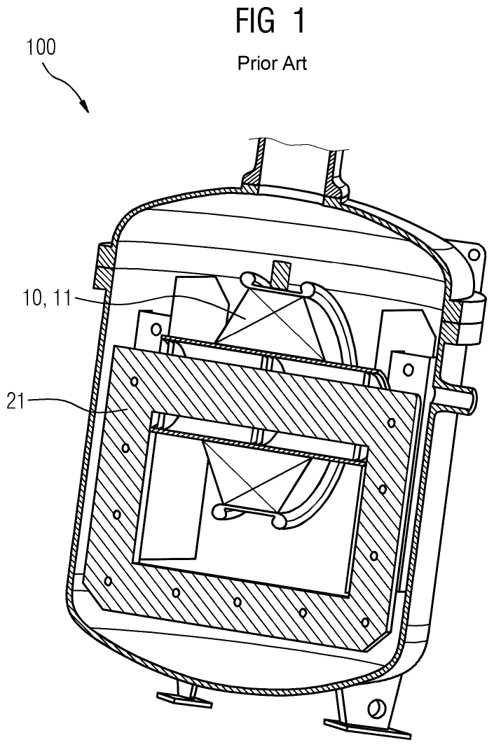

FIG. 1 shows a known design of an inductive power voltage transformer comprising a single (high-voltage) coil assembly.

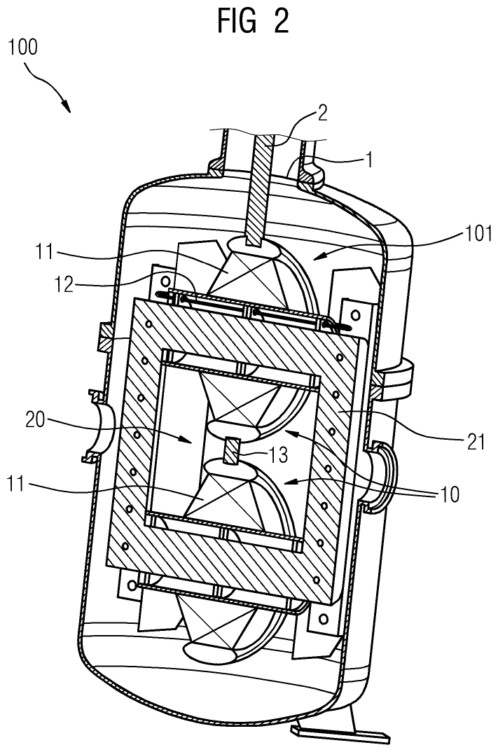

FIG. 2 shows an embodiment of a power voltage transformer comprising the coil assembly according to the invention, comprising two (individual) high-voltage coil components connected in parallel.

In the embodiments and figures, identical or functionally identical elements can in each case be provided with the same reference signs. The elements shown and their size ratios relative to one another are in principle not to be understood as being true to scale, but rather individual elements may be shown excessively thick or large for improved illustration and/or for improved understanding.

FIG. 1 indicates a conventional power voltage transformer 100 comprising a known coil device. The coil shown expediently constitutes a high-voltage coil 10 or a coil pair having a high-voltage winding. In other words, the high-voltage coil 10 comprises a primary winding 11, which is for example to be connected to a voltage to be transformed, and a secondary winding 12. According thereto, the coil is preferably configured as a transformer, as a result of which a high-voltage measurement—just like the coil arrangement according to the invention described from FIG. 2—is made possible or predestined in high-voltage technology energy supply systems.

Furthermore, the coil 10 comprises a magnetic core 21 that is expediently configured for high-frequency applications, preferably made of sheet iron. Further parts of the power voltage transformer comprising the described coil 10 are indicated in part in FIG. 1 but not explicitly denoted by reference signs.

In certain applications of such voltage transformers for high-voltage applications there is a need to increase the power output or the secondary-side overall currents and overall powers of the component. This requirement is met by the coil assembly according to the invention for uses of inductive voltage transformers.

A component 100 according to the invention is described in FIG. 2. The power voltage transformer 100 according to the invention comprises an improved coil assembly 20. In contrast to the assembly of FIG. 1, the coil assembly 20 according to the invention comprises at least two high-voltage coils 10 of the same type that are connected in parallel, wherein both high-voltage coils 10 are in each case—also configured like a transformer—constructed having a primary winding 11 and a secondary winding 12.

The secondary windings 12 of the two coil components 10 are arranged further in a coil interior, visible only to some extent in the present case, in the illustrations by way of example, whereas the high-voltage side primary windings 11 are located further outside.

All or individual coil windings can for example be insulated from one another or in individual layers with oil-paper insulation.

The windings of the high-voltage coils 10, in particular their primary windings 11, are again arranged in a plate-like or toroidal manner around the magnetic core 21. Said magnetic core 21 can preferably be prefabricated for alternating voltage applications or mains operation during production of the coil assembly, in particular from laminated or pressed iron sheets. The winding of the coil(s) then preferably takes place firstly on a supporting tube and only subsequently is the core closed for the magnetic field closure and finished.

Preferably the high-voltage coils 10 of the same type are configured identically.

It can furthermore be seen in FIG. 2 that the two high-voltage coils 10 of the same type are arranged symmetrically on the magnetic core 21. The high-voltage coils 10 are furthermore arranged one above the other in a parallel connection in the superordinate component of the power voltage transformer 100. For this purpose, furthermore an electrical connection or feed-through 13 between the two individual coil assemblies is shown in FIG. 2.

FIG. 2 also shows that the two high-voltage coils 10 of the same type are arranged on or wound around opposite legs of the common magnetic core 21 of the coil assembly 20.

Reference sign 101 denotes a (main) insulating medium 101 within a housing (not denoted further) or boiler of the power voltage transformer 100, which medium may be gaseous, preferably synthetic or purified air.

Unlike what is shown in the present figures, the present invention understandably also comprises a corresponding triple, quadruple or multiple assembly of high-voltage coils of the same type, which can be configured, wound or interconnected analogously to the two high-voltage coins of the same type that are described, and accordingly are associated with the advantages according to the invention. In other words, thus, according to the invention, more than two, i.e. for example three, four or even more, high-voltage coils 10 of the same type can also be wound or arranged—connected in parallel—around the described magnetic core 21.

In the assembly according to the invention of individual high-voltage coil assemblies of the same type, of a specific design, one above the other in parallel, in particular a compact design of the voltage transformer is obtained.

Primarily, however, the design at the same time makes it possible that the overall power or the overall output current of the power voltage transformer can advantageously be increased, indeed in particular doubled. In particular, this technical advantage is achieved in a component of the same core cross-section compared with one according to the illustration in FIG. 1, without a further design of the components or adjustment or optimisation of further parameters being required.

Typically, the high voltage of the voltage transformer is tapped for energy supply apparatuses via a high-voltage connection, in particular an aluminium tube 2. Furthermore, in this case the component expediently comprises insulation 1 surrounding the voltage connection via aluminium tube 2, as can be seen in FIG. 2.

In the present case, the power voltage transformer 100 is shown merely in part or indicated schematically. However, it is evident that the coil concept according to the invention can in principle be used for any type of inductive voltage transformers since it is to be applied in a correspondingly scalable manner. It can therefore be used in a plurality of designs of power voltage transformers.

1. A coil assembly for a power voltage transformer, comprising two high-voltage coils of substantially identical configuration that are connected in parallel, wherein each of the two high-voltage coils includes a primary winding and a secondary winding.

2. The coil assembly according to claim 1, wherein each secondary winding is arranged within the corresponding high-voltage coil, and each primary winding is arranged outside of the corresponding high-voltage coil.

3. The coil assembly according to claim 2, wherein the high-voltage coils are arranged symmetrically around a magnetic core.

4. The coil assembly according to claim 1, wherein the high-voltage coils are arranged on a magnetic core made of one or more laminated iron sheets or configured as a tape-wound core.

5. The coil assembly according to claim 4, wherein the primary windings of the high-voltage coils are wound in such a way that corresponding magnetic field strengths in the magnetic core have a same sense of direction.

6. The coil assembly according to claim 1, wherein the primary windings are each configured to be electrically connected to a high voltage to be transformed.

7. The coil assembly according to claim 2, wherein, when compared with a coil assembly that is configured with an identical magnetic core cross-section but with a single high-voltage coil, is configured to increase an overall power to double that generated by the coil assembly with a single high-voltage coil.

8. A power voltage transformer, comprising the coil assembly according to claim 1, wherein the high-voltage coils are arranged in a parallel connection.

9. The power voltage transformer according to claim 8, wherein the high-voltage coils are arranged one above the other according to an intended assembly of the power voltage transformer.

10. The power voltage transformer according to either claim 8, wherein the high-voltage coils are arranged on opposite legs of a common magnetic core of the coil assembly.

11. The power voltage transformer according to claim 8, further comprising an insulating medium that is any combination of synthetic air or purified air.

12. The coil assembly of claim 1, wherein the coil assembly increases any combination of an overall current and an overall power of a power voltage transformer.
